(19) United States
(12) Patent Application Publication
(10) Pub. No.: US 2005/0059396 A1
(43) Pub. Date: Mar. 17, 2005

(54) Communications protocol between a gateway and an access point

(76) Inventors: Mooi Choo Chuah, Marlboro, NJ (US); Girish Rai, Bartlett, IL (US)

Correspondence Address: Moser, Patterson & Sheridan, LLP, Suite 100, 595 Shrewsbury Avenue, Shrewsbury, NJ, 07702, US

(21) Appl. No.: 10/658,674

(22) Filed: Sep. 9, 2003

(51) Int. Cl. H04Q 7/20

(52) U.S. Cl. 455/435.1

(57) ABSTRACT

A communications protocol in a computer readable medium of a general purpose computer system that operates as a special purpose controller when executing at least one program for broadcasting information. The communications protocol includes an access point location, an access point Internet protocol (IP) address, a media access control (MAC) address, a number of access point radios, and a radio type protocol of each access point radio.

### FIELD OF INVENTION

The present invention generally relates to wireless networks, and more specifically, to communications over wireless local area networks (WLAN).

### BACKGROUND OF INVENTION

Wireless fidelity (Wi-Fi) technology is rapidly gaining acceptance by many corporate and individual entities as an alternative to a wired LAN. Wi-Fi is specified in the 802.11 specification from the Institute of Electrical and Electronics Engineers (IEEE) and is part of a series of specifications together with 802.11, 802.11(a), 802.11(b), and 802.11(g). Wi-Fi access points (called “hot spots”) have been established in various other in public spaces such as in hotels, airports, cafes, bookstores, among other public and private spaces. These “hot spots” enable individuals having mobile devices such as lap tops, PDA's, and the like having wireless capabilities to access a wireless local area network (WLAN) to illustratively send and receive information over the internet. That is, an individual illustratively having a lap top with browser capabilities may access the internet to download email, video and/or audio information, among other information from the internet.

One problem associated with deploying the access points among the various “hot spots” is that each access point must be manually configured. Manually configuring each “hot spot” is time consuming and expensive, especially in instances where numerous access points are being deployed. Furthermore, access points do not provide any quality of service (QOS) related features for an end user. In particular, access points illustratively operating under the 802.11(b) standard are capable of transferring information at a rate of eleven (11) megabits per second (mbps). However, as the number of users access the access point, the bandwidth is divided amongst the users, such that the transfer rate as seen by the users diminishes. Such reductions in the transfer rate that occur when additional users access a particular access point, may hinder those users who require greater transfer rates to receive information from the access point. Therefore, there is a need in the art for a gateway to access point protocol that has automatic configuration capabilities, as well as quality of service related features.

### SUMMARY OF THE INVENTION

The disadvantages heretofore associated with the prior art are overcome by the present invention of a method and communications protocol in a computer readable medium of a general purpose computer system that operates as a special purpose controller when executing at least one program for broadcasting information. The communications protocol includes an access point location, an access point Internet protocol (IP) address, a media access control (MAC) address, a number of access point radios, and a radio type protocol of each access point radio.

The communications protocol may be implemented to register an access point with a gateway in a network, such as a wireless network. In one embodiment, a first method for registering at least one access point with a gateway in a network comprises an access point broadcasting a query message to a plurality of gateways in a network. Accordingly, the broadcasting access point may receive at least one response back respectively from at least one gateway. In particular, the broadcasting access point receives, from at least one gateway, a respective service discovery message. The access point selects an appropriate gateway in an instance where more than one service discovery message is received from more than one gateway, and sends an access point registration request comprising an access point location, IP address, MAC address, radio type, and power level information of said access point to said selected gateway. The selected gateway then stores the access point registration request information, thereby registering the access point with the gateway.

In a second embodiment, a second method for registering at least one access point with a gateway in a network comprises broadcasting, from a gateway, a discovery message to at least one access point in a network. Each access point receiving the discovery message sends an access point registration request comprising access point location, IP address, MAC address, radio type, and power level information of the access point to the broadcasting gateway. The broadcasting gateway then stores the access point registration request information, thereby registering the access point.

### BRIEF DESCRIPTION OF THE DRAWINGS

The teachings of the present invention can be readily understood by considering the following detailed description in conjunction with the accompanying drawings, in which:

FIG. 1 depicts a block diagram of a first embodiment of a wireless network suitable for use in the present invention;

FIG. 2 depicts a block diagram of a second embodiment of a wireless network suitable for use in the present invention;

FIG. 3 depicts a block diagram of an exemplary gateway suitable for use in the wireless networks of FIGS. 1 and 2;

FIG. 4 depicts an exemplary access point suitable for use in the wireless networks of FIGS. 1 and 2;

FIG. 5 depicts a flow diagram of a method for storing a new access point in the wireless networks of FIGS. 1 and 2;

FIGS. 6A and 6B collectively depict a flow chart of a second method for storing a new access point in the wireless networks of FIGS. 1 and 2;

FIG. 7 depicts a block diagram of a data structure suitable for sending an access point registration request message to one or more gateways in the wireless networks of FIGS. 1 and 2;

FIG. 8 depicts a flow diagram of a method for initiating a service session for a mobile host at an access point;

FIG. 9 depicts a block diagram of a third embodiment of a wireless network suitable for use in the present invention;

FIG. 10 depicts a flow diagram of a method for roaming between access points of the wireless network of FIG. 9.

To facilitate understanding of the present invention, identical reference numerals have been used, where possible, to designate identical elements that are common to the figures.

### DETAILED DESCRIPTION OF THE INVENTION

The present invention provides a communications protocol (data structure) and associated methods for systematically configuring new gateways and/or access points installed in a wireless network environment, thereby reducing the time and cost associated with setting up or modifying a wireless network, such as a wireless fidelity local area network. Furthermore, the method and communications protocol of the present invention provide a quality-of-service (QOS) related features for end users illustratively of the wireless network environment. The communications protocol and method of the present invention are illustratively described in the context of a wireless network having a plurality of gateways and access points, however, one skilled in the art will appreciate that the communications protocol and associated methods may be implemented in other types of network environments, such as Hyperlan, wireless personal area networks, 802.16 protocol networks, among others.

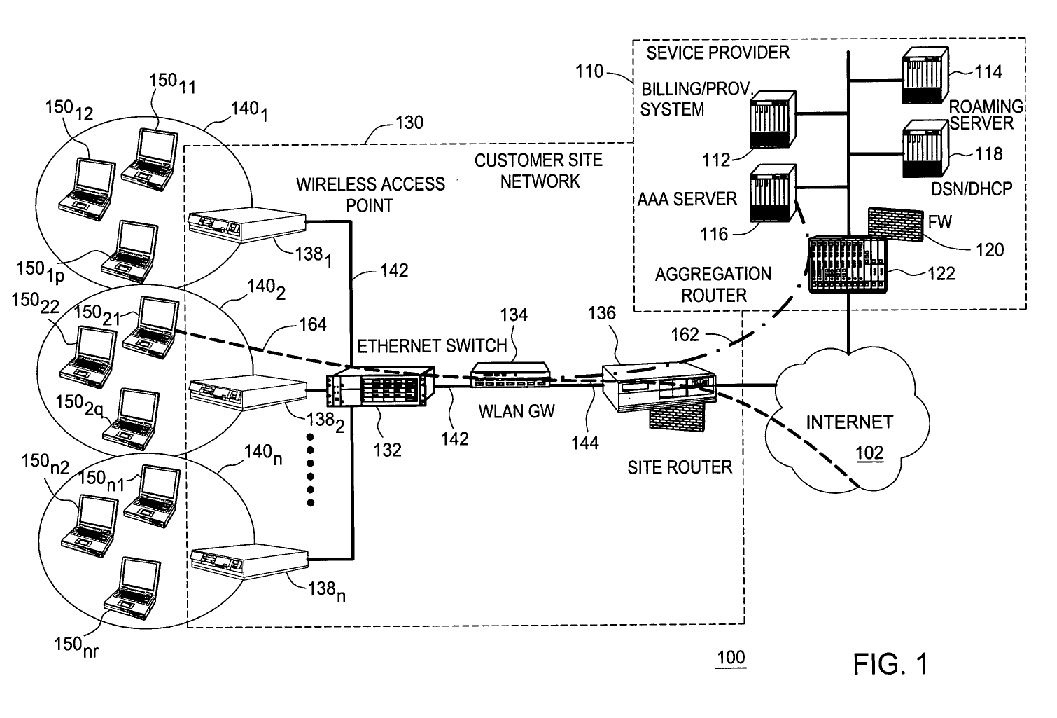

FIG. 1 depicts a block diagram of a first embodiment of a wireless network 100 suitable for use in the present invention. In particular, the exemplary wireless network 100 is a decentralized network comprising a wireless service provider 110, a customer site network 130, a plurality of mobile hosts 150₁₁ through 150ₙᵣ (collectively mobile hosts 150) and a public network, such as the internet, 102. The mobile hosts 150 communicate with the customer site via wireless communications, illustratively under the 802.11(a), 802.11(b), 802.11(g), Bluetooth standards, among other wireless communication standards. The customer site network 130 typically comprises an Ethernet based network (e.g., fast Ethernet) and communicates with the service provider 110 via a gateway over a high speed communications network, such as a T-1 or T-3 wired carrier lines, or digital subscriber lines (DSL), such as Asymmetric DSL (ADSL), High bit-rate DSL (HDSL), and the like.

The service provider 110 comprises a billing/provisioning system server 112, a roaming server 114, an authentication, authorization and accounting (AAA) server 116, and a domain name server/dynamic hosts configuration protocol server (DNS/DHCP) server 118, a firewall 120, and an aggregation router 122. The service provider 110 is coupled to the customer site 130 via the internet 102, via the firewall 120 and aggregation router 122.

The customer site 130 comprises a site router 136 illustratively having a firewall, a wireless local area network gateway 134, an Ethernet switch 132 and a plurality of wireless access points 138₁, through 138ₙ (collectively access points 138). As will be discussed in further detail below, each access point 138 is associated with one or more “hot spots” such as “hot spots” 140₁, through 140ₙ (collectively “hot spots” 140), which enable wireless communications between one or more wireless mobile hosts 150 and each of the access points 138. As illustratively shown in FIG. 1, wireless hosts 150₁₁, through 150₁ₚ communicate with access point 138₁ via the “hot spot” 140₁. Similarly, mobile hosts 150₂₁ through 150_{2q} may communicate with access point 138₂ via the “hot spot” 140₂, and so forth.

The mobile host (e.g., 150₁₁ through 150ₙᵣ) may be any computer device having wireless capabilities, as well as internet browsing and email messaging capabilities. For example, a mobile host may be a lap top computer, a PDA, a cellular phone, or any other wireless communication devices having Internet capabilities.

The AAA server 116 of the service provider 110 handles user requests for access to the wireless services and provides authentication, authorization, and accounting services. The AAA server 116 interacts with the gateway 134 at the customer site 130 via path 162, as discussed in further detail below. The billing/provisioning server 112 maintains a database of billing records of each subscriber for services, and provides billing information for services rendered by the service provider 110. The billing/provisioning server 112 interacts with the AAA server 116 once the subscriber of wireless services has been authenticated.

The roaming server 114 of the service provider 110 tracks the locations of the mobile hosts 150 during their connectivity to the access points 138. When a mobile host, such as the mobile host 150₁₁ that is connected to a first access point 138₁, roams to a second access point 138₂, the roaming server 114 tracks the new location of the mobile hosts 150₁₁.

The DNS/DHCP server 118 translates domain names into internet protocol addresses and centrally manages and automates the assignment of IP addresses in the service provider's network. That is the DNS/DHCP server dynamically assigns a unique IP address to each of the mobile host 150 that seek connectivity to the wireless network 100, as is conventionally known in the art. The plurality of access points 138 of a customer site 130 are coupled to an Ethernet switch 132 via physical wiring such as optical fiber, fast Ethernet (e.g., gigabyte Ethernet, 10 gigabyte Ethernet) and the like. The Ethernet switch 132 is coupled to the customer site gateway 134, which provides access to the service provider 110 and the internet 102 via a customer site router 136 (and firewall). The Ethernet switch 132, gateway 134, and the site router 136 together form a backbone of the customer site network 130.

Each of the access points 138 comprise one or more radio transceivers (not shown) that establish a respective “hot spot” 140 to allow a plurality of mobile hosts 150 to communicate with the access points according to the 802.11 standards, Bluetooth standards, among other wireless communication standards. Specifically, a mobile host (e.g., mobile hosts 150₁₁) seeking Internet services provided by the service provider 110 sends a registration request to the access point 138 via wireless communications. The access point 138 forwards the registration request to the AAA server 116 of the service provider 110 via the Ethernet switch 132, gateway 134, site router 136, and an aggregation router 122. The AAA server 116 authenticates and authorizes the user. If such user is found to be a subscriber for such services, the AAA server 112 assigns an IP address and sends the user profile information, such as session key information, QoS profile information, allowable session time, and the like, to the WLAN gateway 134. The roaming server 114 serves as a network manager to allow a system administrator to identify and display the active users, the number of users per access point, and other administrative functions. The DNS/DHCP server allocates the IP address dynamically to the users once the users have been authenticated.

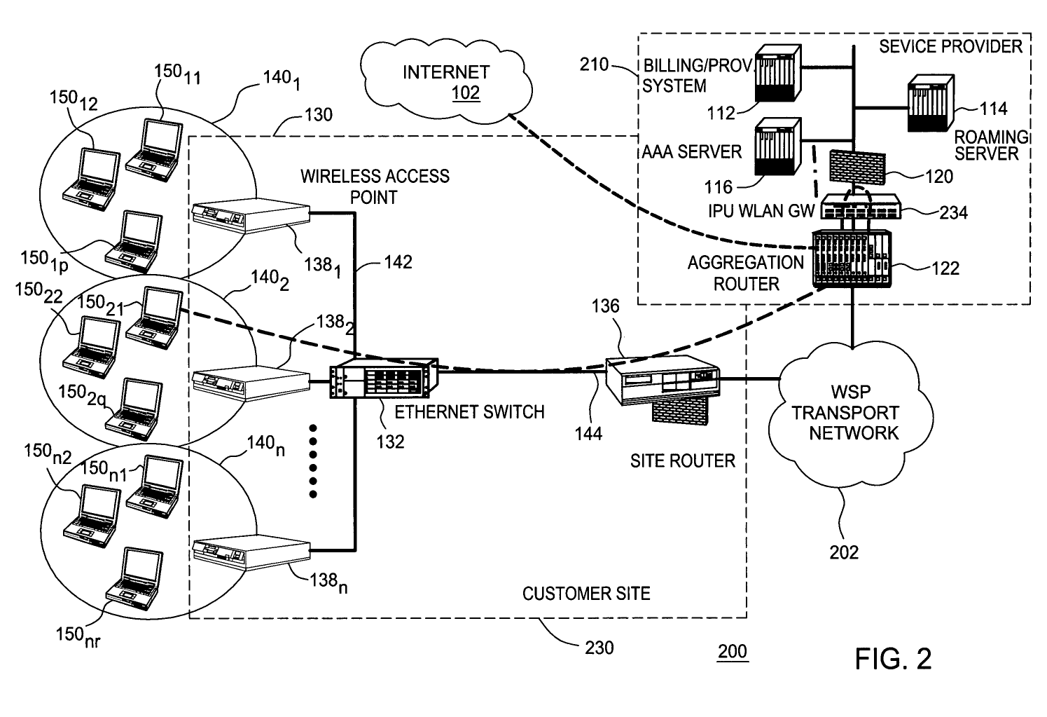

FIG. 2 depicts a block diagram of a second embodiment of a wireless network 200 suitable for use in the present invention. The network 200 of FIG. 2 is a centralized network having the same structure as the network of FIG. 1 except that the gateway 134 is now installed as part of the service provider equipment 110, as opposed to the customer site network 130. In particular, the billing/provisioning server 112, AAA server 116, and IP roaming server 114 are coupled to the gateway 234 via the firewall 120. The gateway 234 is coupled to the Internet 102 and a wireless service provider transport network 202 via the aggregation router 122. In one embodiment the wireless service provider (WSP) transport network 202 may be a hybrid fiber co-axle (HFC) network, an optical fiber network, among other transport networks. The customer site 230 illustratively comprises the access points 130₁ through 130ₙ, which are coupled to the Ethernet switch 108, as discussed above with respect to FIG. 1. The Ethernet switch 108 is coupled directly to the site router and firewall 136, which is then coupled to the WSP transport network 202. During operation, a user of a mobile host 150 accesses an access point 138 via wireless communications from the mobile host 150 and sends a registration request for services to the AAA server 116 of the service provider 210, which then authenticates, authorizes and enables subscribers of such services to receive access to the internet 102, as is conventionally know in the art.

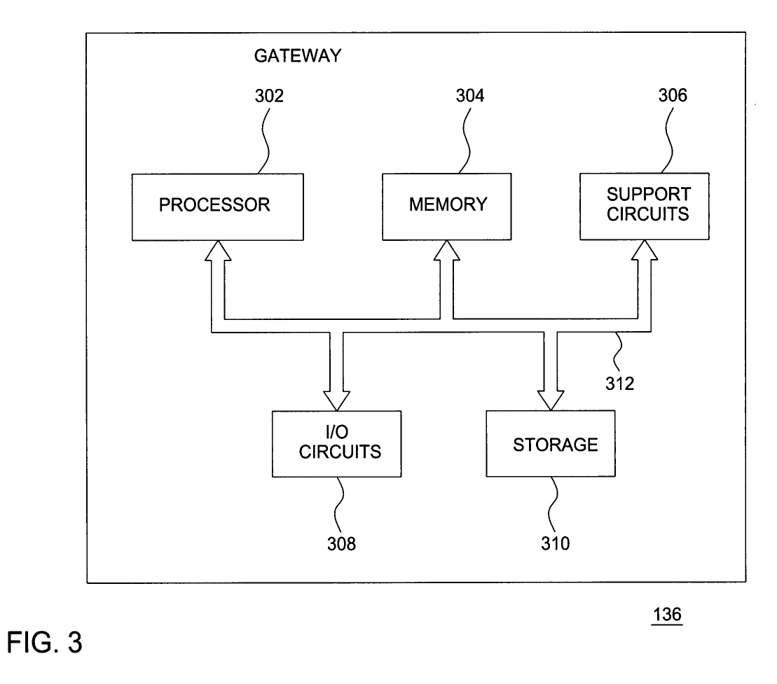

FIG. 3 depicts a block diagram of an exemplary gateway 136 suitable for use in the present invention. In particular, the exemplary gateway 136 comprises a processor 302, memory 304, support circuits 306, I/O circuitry 308, and one or more storage devices 310 illustratively coupled via one or more buses 312. Specifically, the processor 302 cooperates with conventional support circuitry 306, such as power supplies, clock circuits, cache memory, and the like, as well as circuits that assist in executing the software routines stored in the memory 304. As such, it is contemplated that some of the process steps discussed herein as software processes may be implemented within hardware, for example, a circuitry that cooperates with the processor 302 to perform various steps.

The memory 304 may be volatile memory, such as DRAM, SRAM, and the like. The storage device 310 may be non-volatile memory such as disc drives, programmable read only memory (PROM) and the like, and the IO circuitry may include various ports that form an interface between the various function elements communicating with the gateway 136. For example, in the embodiment of FIG. 1, the gateway 136 communicates with the Ethernet switch 132 and the site router 136.

Although the gateway of FIG. 3 is depicted as a general purpose computer that is programmed to perform various control functions in accordance with the present invention, the invention can be implemented in hardware such as, for example, an application specific integrated circuit (ASIC). As such, it is intended that the processes described herein be broadly interpreted as being equivalently performed by software, hardware, or a combination thereof.

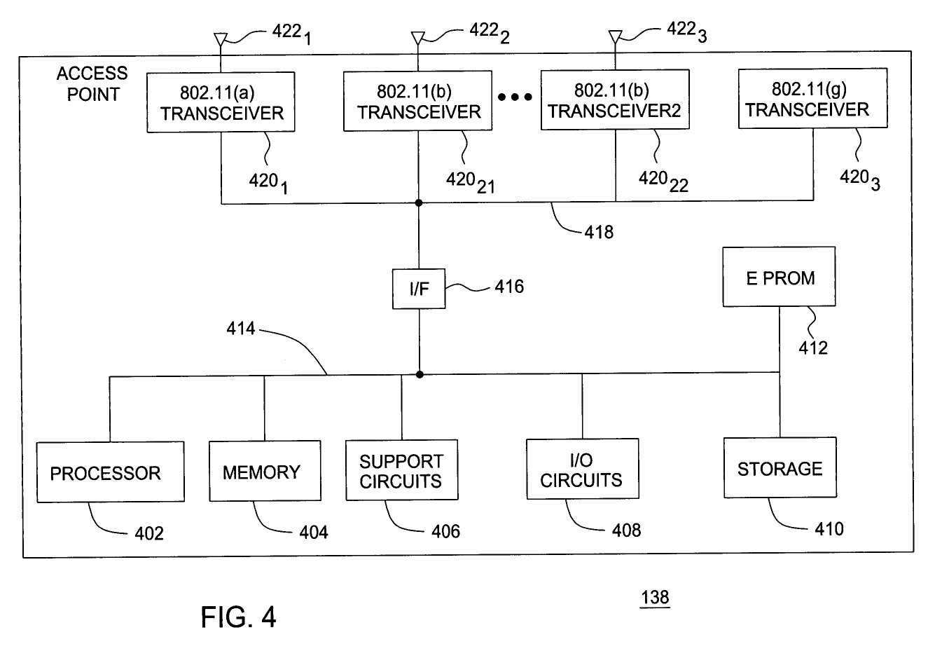

FIG. 4 depicts a block diagram of an exemplary access point 138 suitable for use in the present invention. Specifically, the access point 138 comprises a processor 402, memory 404, support circuits 406, IO circuits 408, at least one storage device 410, and an optional EPROM 412, which are illustratively coupled via one or more local buses 414. The processor 402 cooperates with the conventional support circuits 406, such as power supplies, clock circuits, cache memory, and the like, as well as circuits that assist in executing the software routines stored in the memory 404. As such, it is contemplated that some of the process steps discussed herein as software processes may be implemented within hardware, for example, as circuitry that cooperates with the processor 402 to perform various steps.

The memory 404 may be volatile memory such as DRAM, SRAM, and the like, while the storage device 410 may be non-volatile memory such as one or more disc drives or any other non-volatile storage medium device. The I/O circuits 408 form an interface between various functional elements communicating with the access point 138. The above-mentioned components (i.e., memory 404, storage device 410, support circuits 406, processor 402, and I/O circuits 408) are coupled to the one or more local buses 414. The local buses 414 are in turn, coupled to one or more peripheral buses 418 via an interface (bridge) 416. A plurality of transceivers 420₁ through 420₃ are illustratively connected to the peripheral bus 418 to support wireless communications between the access point 138 and the wireless mobile host 150.

In the illustrative embodiment of FIG. 4, the first transceiver 420₁ operates under the 802.11(a) standard, the second transceiver 420₂ operates under the 802.11(b) standard, while the third exemplary transceiver 420₃ operates under the 802.11(g) standard. It is noted that each of these transceivers communicates with the subscriber wireless host device 150 via a respective antenna 422₁ through 420₃ (collectively antennas 422). It is further noted that each of the transceivers comprises base-band processing circuitry (not shown) coupled to the radio frequency (RF) transmitters and receivers. Each of the base-band processing circuitry performs digital processing for a respective wireless communication protocol (e.g., 802.11(a), 802.11(b), and 802.11(g)), service by the access point 138. While the access point 138 illustrated in FIG. 4 is shown to support three separate wireless communication protocols, other embodiments of the access point 138 may support one, two, or more than three communication protocols.

Furthermore, it is noted that more than one transceiver may be implemented to support each of the wireless communication protocols. For example, as shown in FIG. 4, two transceivers 420₃₁ and 420₃₂ are illustratively provided to provide wireless communications under the 802.11(g) standard. In this instance, the two receivers 420₃₁ and 420₃₂ operate in different frequency channels. It is noted that under the 802.11(b) standard, a total of eleven channels may be provided of which only three are non-overlapping channels.

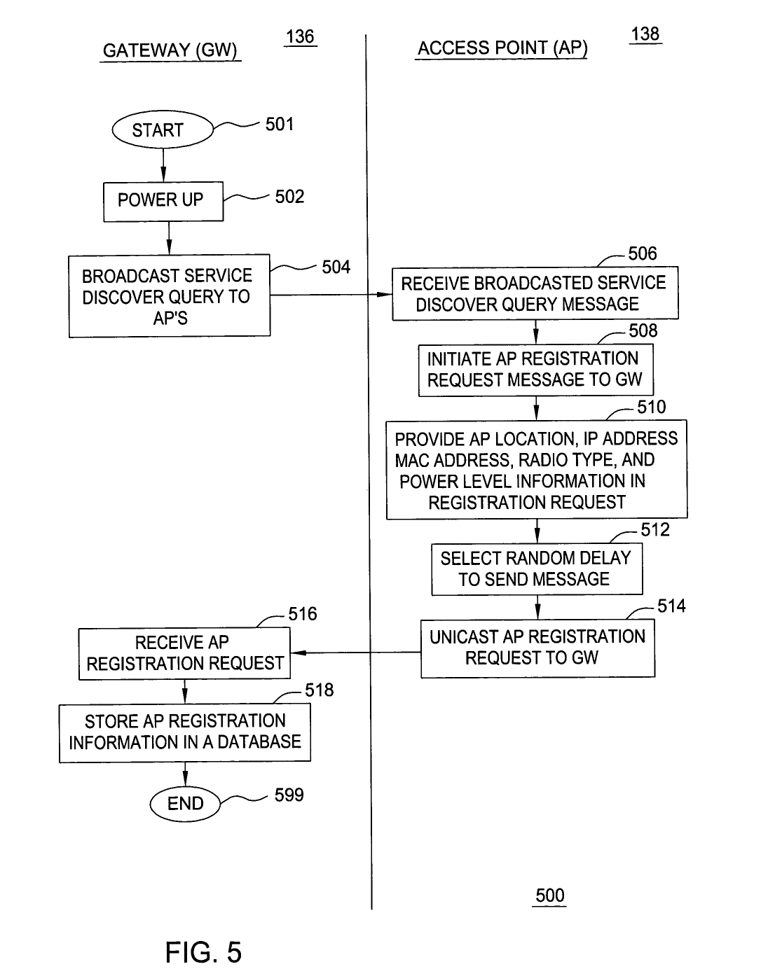

FIG. 5 depicts a flow diagram of a first method for registering an access point (AP) with a gateway (GW) 136. The flow chart of FIG. 5 is divided into two columns with the functional aspects of the gateway 136 in the left column and the functional aspects of the access point 138 in the right column. The method 500 of FIG. 5 illustrates how an access point 138 is registered with a gateway 136 when a gateway 136 is powered up. The method 500 begins at step 501 and proceeds to step 502 where a gateway 136 is powered up in the network 100. At step 504, the gateway 136 broadcasts a service discovery query to the AP's 138 in the network 100. The method 500 then proceeds to step 506.

At step 506 the AP's 138 in the network 100 receive the broadcasted service discovery query message from the newly powered up gateway 136. At step 508 the access point receiving the service discovery query message initiates an AP registration request message to be sent to the gateway 136.

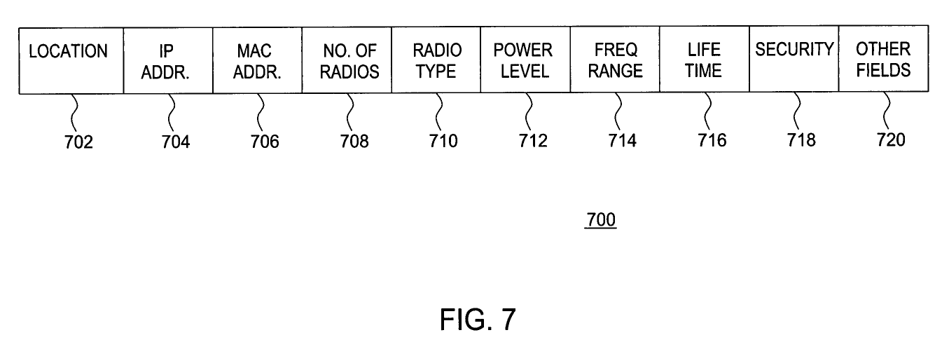

FIG. 7 depicts a data structure of an exemplary AP registration request message 700. Referring to FIG. 7, the data structure of the AP registration request message 700 comprises a plurality of fields, including a location field 702, and IP address field 704, a MAC address 706, number of radios 708, radio types 710, power level 712, frequency channel field 714, lifetime field 716, and a security field 718, among other fields 720. The location field 702 illustratively comprises alpha-numeric characters describing the location of the access points. The IP address field 704 includes the unique IP address of the access point 138, while the MAC address 706 contains the unique MAC address of the access point 138. As noted above with respect to FIG. 4, more than one radio may be installed in each access point. Accordingly, field 708 contains the number of radios installed in the access point 138. Field 710 defines the radio type, for example, such as the 802.11(a) transceiver 802.11(b) transceiver, or 802.11(g) transceiver. Field 712 provides the power level of the radio being utilized by the access point 138. Furthermore, the frequency channel field 714 provides the frequency channel of the channel being utilized by the radio of the access point 138. For instance, under the 802.11(b) protocol, a total of eleven channels are available with three of such channels being non-overlapping channels.

The lifetime field 716 comprises one or more bytes that are set to establish a permanent association between the access point 138 and the gateway 136, or a temporary association there between. In one embodiment, if the lifetime field is set to all 1's, a permanent association between the access point and gateway is created. Otherwise, the access point 138 is required to refresh the AP/gateway association before the lifetime expires. The lifetime may be set to a time period such as a day or days, week, or otherwise to refresh itself with the gateway. In this later embodiment, the periodic refreshing serves as a heartbeat of the AP 138, such that the health of the AP 138 may be periodically determined.

The security field 718 may illustratively include 64-bit or 128-bit wireless equivalent privacy (WEP) keys under the 802.11 standard, which can be used each access point 138, or any other private keys that allow a gateway 134 to communicate with each access point 138. It is noted that other fields 720 may include, quality of service information, and the like, as required.

Referring to FIG. 5, at step 510, the access point 138 provides the AP location, IP address, MAC address, radio type, and power level information in the registration request 700. As discussed above, if the AP 138 comprises more than one radio, then the number of radios and frequency channels of the radio is also included in the registration request 700. The method then proceeds to step 512. At step 512, the access point 138 selects a random delay to send the AP registration request message.

Since the gateway 136 has broadcasted the discovery query to all of the AP's 138 in the network 100, each access point 138 selects a random delay to send a message in order to avoid collisions of the messages from all of the AP's when being sent back to the gateway 136. In one embodiment the random delay that is selected is between 0 and 100 milliseconds. Once the random delay is selected by the AP 138, the AP 138 unicasts the AP registration request 700 to the gateway 136 that broadcasted the service discovery query.

At step 516, the broadcasting gateway 136 receives the AP registration request message from the access point 138 and at step 518, stores the registration information in a database. That is, the gateway 136 builds a database of all the AP's that register with it such that the gateway 136 can support a hand-off feature when a mobile host 150 roams between one “hot spot” 140 and another “hot spot”. The method then proceeds to step 599 where the method 500 ends.

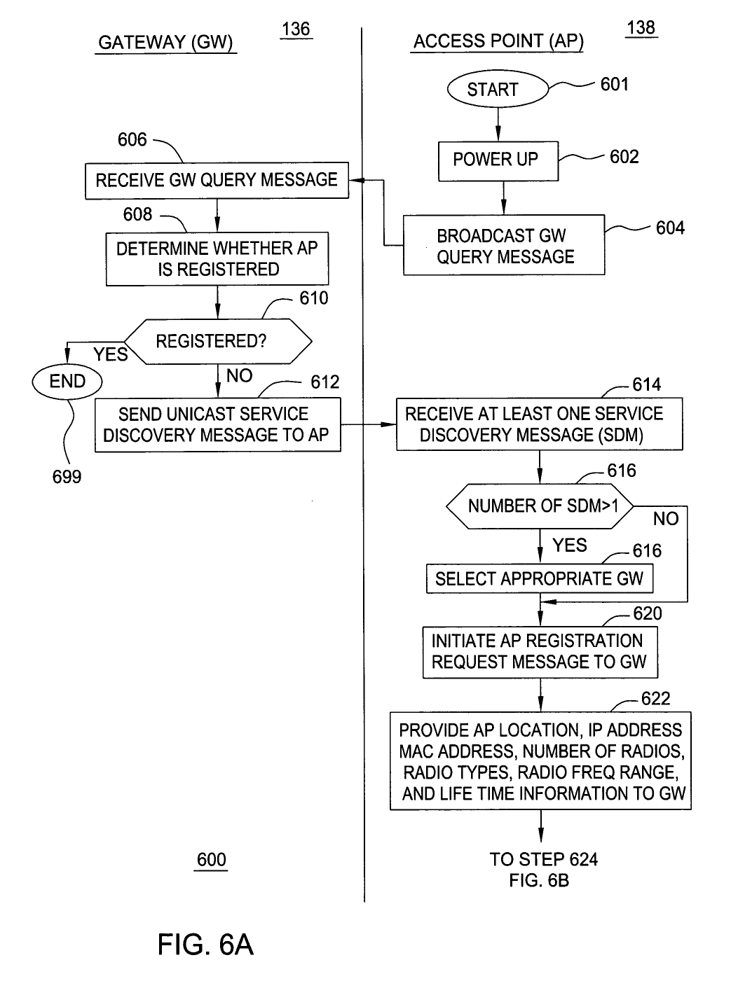

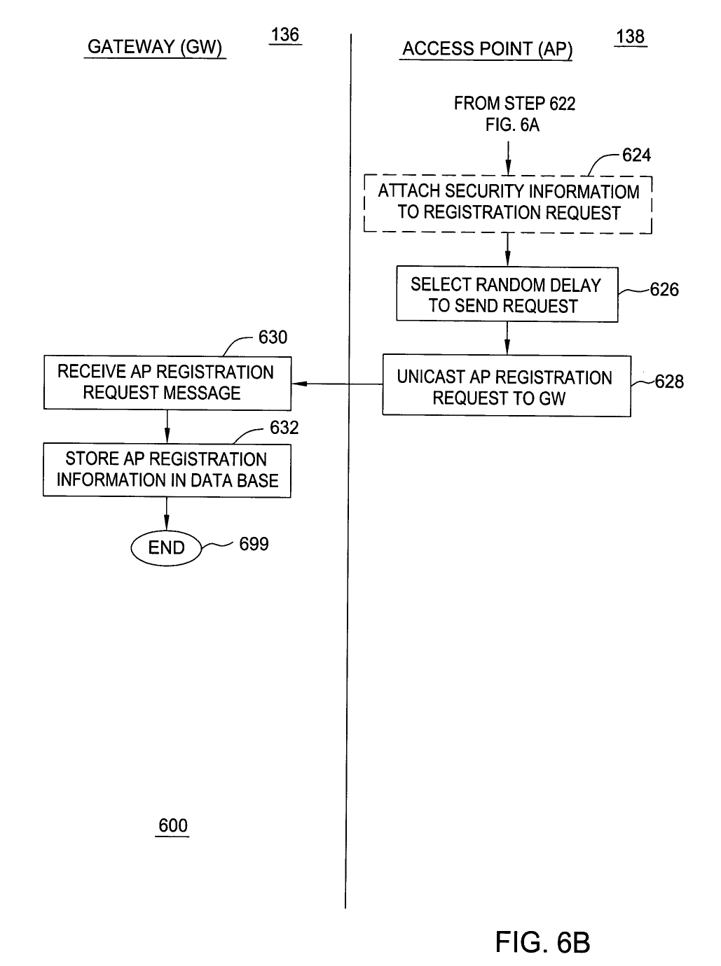

FIGS. 6A and 6B collectively depict a flow diagram of a second method 600 of registering an access point 138 with a gateway 136. FIGS. 6A of 6B are divided into two columns where the functional aspects of the gateway 136 are shown on the right side, while the functional aspects of the access point 138 are shown on the left side of the FIGS. The method 600 starts at step 601 and proceeds to step 602, where an access point is powered up 602. Specifically, a new access point may be installed in a network 100 or a previously installed access point may be rebooted, for example, to download a new software image, recover from a power failure, and the like. The method 600 then proceeds to step 604. At step 604, the access point broadcasts a gateway query message over the network 100.

At step 606, a gateway 136 in the network 100 receives the gateway query message, and at step 608, each of the gateways in the network 100 determines whether the AP that broadcasted the gateway query message is registered. That is, each gateway checks its database of registered access points to determine whether the broadcasting access point 138 is registered therewith. If at step 610 the broadcasting AP 138 is registered with the gateway, the method 600 proceeds to step 699 where the method 600 ends. If at step 610 the broadcasting AP 138 is not registered at the gateway 136, at step 612 the gateway 136 sends a unicast service discovery message to the broadcasting AP 138. That is, each gateway in the network 100 that does not contain a record of the broadcasting AP as being a registered AP therewith, then sends a unicast service discovery message to that broadcasting AP. The method 600 then proceeds to step 614.

At step 614, the broadcasting AP 138 receives at least one service discovery message (SDM) from the gateways 136 that do not have the broadcasting AP registered. At step 616, the AP 138 determines whether the number of SDMs is greater than one. In other words, the access point determines whether it has received more than one service discovery message. If the number of SDMs the broadcasting AP receives is not greater than one, then the method 600 proceeds to step 620 where the AP initiates an AP registration request message to the gateway. If however, the number of SDMs is greater than one, then the method 600 proceeds to step 618, where the access point 138 selects an appropriate gateway for registration. Determining factors for selecting an appropriate gateway include costs of using the gateway, load at each gateway, system features provided by each gateway, and the like. The method 600 then proceeds to 620, where the AP 138 initiates an AP registration request message to the selected gateway. The method then proceeds to step 622.

At step 622, the AP provides the AP location, IP address, MAC address, number of radios, radio type, radio frequency channel, and lifetime information in the registration request 700, as discussed above with regard to FIG. 7. At step 624, the AP optionally attaches security information to the registration request 700. The security information of field 718 of the registration message 700 illustratively provides a key to encrypt any message exchange between the gateway and each access point. Thus, a rogue access point is blocked from eavesdropping during an exchange of messages between another access point and a gateway.

At step 626, the AP selects a random delay to send the registration request to a gateway, and at step 628, the AP 138 unicasts the AP registration to the selected gateway, as discussed above with respect to steps 512 and 514 of FIG. 5. At step 630, the selected gateway receives the AP registration request message, and at step 632 the selected gateway stores the AP registration information in a database therein, thereby registering the access point with that particular gateway. The method 600 then proceeds to step 699 where the method 600 ends.

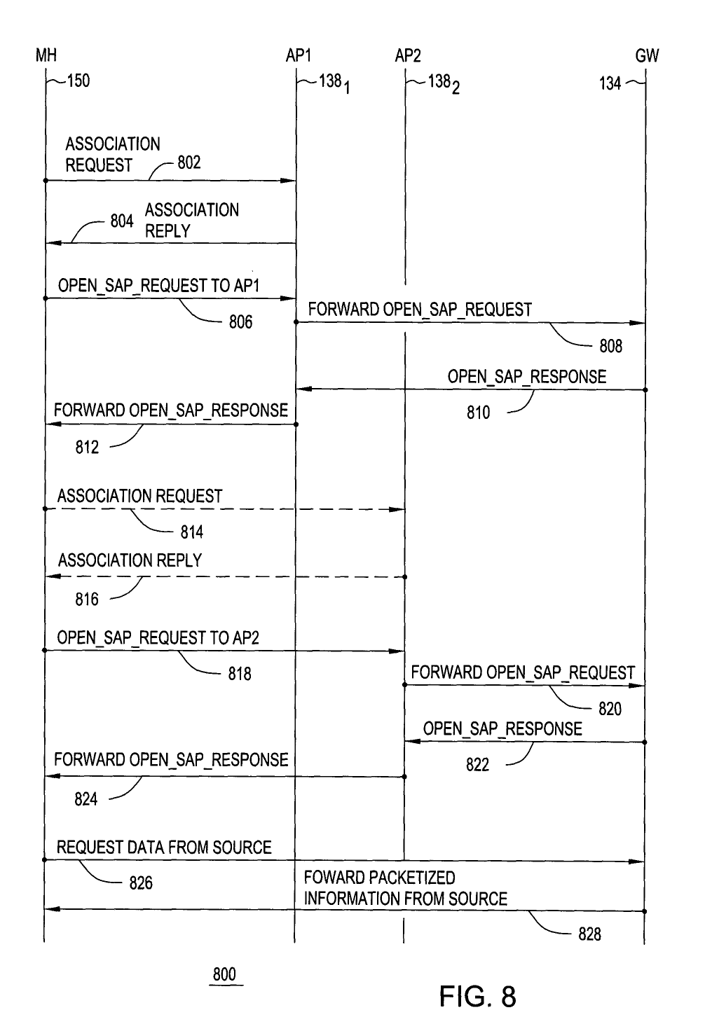

FIG. 8 depicts a flow diagram of a method 800 for initiating a service session for a mobile host 150 at an access point 138. Once the access points 138 and gateways 134 in the network 100 have been implemented and registered with each other by the service provider 110, the user of a mobile host 150 may seek access to the internet 102 via an access point 138. In the flow diagram of FIG. 8, communications between a mobile host 150, a first access point 138₁, a second access point 138₂, and a gateway 134 are illustratively shown. At step 802, the mobile host 150 sends an association request to the first access point 138₁, in a manner conventionally known in the art. Upon receiving the association request, at step 804, the first access point 138₁, sends an association reply back to the mobile host 150 also in a manner conventionally known in the art.

Once the mobile host 150 has been associated with a particular access point 138 (e.g., AP 138₁), the mobile host 150 may then request services, such as internet access, from the service provider 110. In particular, at step 806, the mobile host 150 sends an open service access point (SAP) request (e.g., open_SAP_request) message to the gateway 134 via its associated access point 138. The open_SAP_request may illustratively include, as required, an identifier to identify a particular wireless modem (e.g., wireless LAN card installed in the mobile host), the number of elements in a connection group, an array of connections, any other user data, and a list of the access points 138 that the mobile host 150 may be in communication range.

Specifically, each access point 138 sends out a beacon signal operating at a predefined frequency. That is, each access point beacon signal operates at a predetermined frequency that is different from any other nearby (adjacent) access point beacon signal in the vicinity. As a mobile host 150 comes within range of a beacon signal (e.g., approximately 100 feet) of an access point, the mobile host 150 is then able to establish communications with that particular access point 138.

Referring to FIG. 1, mobile host 150₁ₚ may receive a first beacon signal from the access point 138₁, as well as a second beacon signal from the access point 138₂, which is in close proximity (e.g., 100 feet) of the first access point 138₁. For example, a shopping mall having two independently operated stores (merchant customer sites) located nearby (e.g., adjacent) to each other, may have an access point 138 proximately located. Alternatively, a single entity (merchant) may provide multiple access points 138 to facilitate a large number of users at a particular location for its customers. Once a mobile host 150 receives one or more beacon signals, the mobile host 150 includes in its open_SAP_request message to the gateway 134, a list of those access points associated with a respective beacon signal received (i.e., heard) by the mobile host 150. For example, if a MH 150 receives (hears) three beacon signals from three different access points, then three access point identifiers corresponding to those three access points are included in the open_SAP_request message to the gateway 134.

Furthermore, the request for services may include various grades of quality-of-service (QoS) information. The grades of service are quality of service levels, which illustratively include constant bit rate (CBR), variable bit rate (VBR), real-time variable bit rate (VBR-rt), controlled load, guarantee service, best effort services, among other services known in the industry. In one embodiment, best effort level of service may be a default level of service. However, in those instances where a user requires requested information (e.g., video stream) without delay or artifacts that may occur when using best effort level of service, the user may request a guaranteed service level, which provides dedicated bandwidth to provide the requested information.

As noted above, the mobile host 150 may also include in the open_SAP_request message a number of elements in a connection group. In particular, a user may wish to establish multiple session connections with a gateway, where each session has a different quality of service level. For example, one session may have dedicated bandwidth, while a second session only requires a best effort service level. In this example, there will be two elements in the connection group. Moreover, each entry in the array contains information about one connection element in the connection group.

At step 808, the associated access point 138 forwards the open_SAP_request message to the gateway 134. In particular, the access point 138 identifies, from a database stored in memory 404, a particular gateway 134 it is currently registered with, and the access point 138 sends the open_SAP_request message to its associated registered gateway 134.

The registered gateway 134 receiving the open_SAP_request message then determines whether the user is a subscriber for services provided by the service provider 110. That is, the gateway communicates with the AAA server 116 of the service provider 110 to confirm the user as a subscriber, and the billing/provisioning system 112 to track the billing information.

If the user is not a subscriber, then the request is rejected, and in one embodiment, the user may be offered an opportunity to become a subscriber. Otherwise, the gateway 134 sends a termination message to the access point 138, which is forwarded to the mobile host 150. However, if the user is determined to be a subscriber for services, then the gateway 134 determines whether the mobile host 150 should associate with the requested access point (e.g., AP 138₁) or another access point that is within the range of the mobile host 150, such as exemplary access point 138₂. In particular, the gateway 124 may determine that the access point where the open_SAP_request message originated is being over utilized (i.e., reaching or reached maximum bandwidth capacity). Therefore, gateway may perform load balancing by rejecting the open_SAP_request message with an appropriate error code and include a different access point for the mobile host 150 to associate with. The method then proceeds to step 810.

At step 810, the gateway 134 sends an open_SAP_response message back to the originating access point (with the appropriate access point identifier). For purposes of better understanding the load balancing aspect of the invention, it is assumed that the gateway 134 has determined that the first access point 138₁ is being over utilized. The gateway 134 includes in the open_SAP_response message a rejection code associated with the open_SAP_request message from the first access point 138₁, as well as the AP identifier for a suitable access point, such as AP2 138₂. That is, since the gateway 134 knows which access points the mobile host can hear, the gateway is capable of selecting one of those access points suitable for providing services for the mobile host 150, as well as providing load balancing. The gateway sends the open_SAP_response message to the originating access point 138₁, and at step 812, the receiving access point (i.e., AP 138₁) forwards the open_SAP_response message back to the mobile host 150.

Optional steps 814 and 816 illustrate communications between the mobile host 150 and a second access point, in an instance where the gateway 134 rejected the open_SAP_request message from a first access point 138₁ and identified a second access point 138₂ to provide connectivity. In particular, at optional step 814 (drawn in phantom), the mobile host 150 sends an association request to the exemplary second access point 138₂ in an instance where the gateway 134 determined that the first access point 138₁ was not suitable (e.g., for purposes of load balancing) to provide a wireless connection for the mobile host 150. Then, at step 816 (also drawn in phantom), the second access point 138₂ sends an association reply back to the mobile host 150 in a manner conventionally known in the art.

At step 818, the mobile host 150 sends an open_SAP_request to the gateway 134 via the second access point 138₂. Specifically, at step 818, the mobile host 150 sends an open_SAP_request to the second access point 138₂. At step 820, the second access point 138₂ forwards the open_SAP_request to the gateway 134. At step 822, the gateway 134 sends an open_SAP_response to the mobile host 150, also via the second access point 138₂. Specifically, at step 822, the gateway 134 sends an open_SAP_response to the second access point 138₂. At step 824, the second access point 138₂ forwards the open_SAP_request to the mobile host 150.

It is noted that the open_SAP_request and open_SAP_response contain similar information as discussed above with respect to the open_SAP_request/response sent to the first access point 138₁. That is, the gateway 134, may determine that the second access point 138₂ is no longer suitable for providing wireless communications for the MH 150, and select another access point (i.e., radio transceiver) to provide wireless connectivity.

Once the gateway 134 sends an acceptance code in the open_SAP_response for a particular access point (e.g., AP2 138₂), at step 826, the user may communicate and request data from a particular source of information, illustratively over the Internet. For example, the user may illustratively browse an Internet browser of the mobile host 150, and send a request for data from a web site on the Internet 102 through the exemplary second access point 138₂ to the gateway 134. The gateway 134 then sends the request to the site router 136 to a data source (e.g., data server) on the Internet 102. At step 828, the gateway 134 receives the requested information (packetized information) from the data source on the Internet 102 via the customer site router 136, and forwards the packetized data to the mobile host 150, via the exemplary second access point 138₂. It is noted that if the gateway 134 had accepted the first open_SAP_request for the first access point 138₁ in the open_SAP_response of steps 810 and 812, the method 800 would have proceeded directly to step 824 to allow the user to communicate with a data source, illustratively on the Internet 102, via the first access point 138₁ and the gateway 134.

It is noted that one skilled in the art will appreciate that a mobile host 150 and gateway 134 may also perform similar functions described above using Mobile-IP registration/response messages with additional information fields. That is, instead of using open_SAP_request/response messages, Mobile-IP registration messages having information fields containing access point information may alternatively be utilized.

Referring to FIGS. 1 and 4, in one embodiment, load balancing may be provided in an instance where many users are associated with one of a plurality of transceivers 420 of a common access point 138. For example, in FIG. 4, if the second transceiver 420₂₁, which operates under the 802.11(b) protocol, is primarily being utilized in the access point 138, then the transceiver 420₂₁ is capable of providing 11 mbps to all of the users associated with that transceiver. If 11 users are receiving service from that particular transceiver 420₂₁, then each mobile host 150 associated with that transceiver 420₂ is only receiving one megabyte per second worth of data.

Accordingly, the gateway 134 is also capable of providing load balancing to relieve a transceiver 420 from over usage, which results in diminished bandwidth capacity for each user. Specifically, the gateway 134 monitors the number of users and the type (i.e., radio protocol) of transceiver providing such services.

To provide load balancing, the gateway 134 rejects an open_SAP_request or registration request from a new user, thereby forcing the LAN card of the MH 150 to reassociate with a different transceiver 420 in the access point 138. For example, a mobile host 150 that initially associates with the gateway 134 via an exemplary first transceiver 420₁ operating on channel 2 of access point 138₁, will include in the open_SAP_request message, any other transceivers (e.g., transceivers 420₂₁, 420₂₂, and 420₃) in the same access point 138₁, as well as other access points (e.g., AP2 138₂) within range of the MH 150. In a response back to the mobile host 150, the gateway 134 may include a rejection code in the response, as well as a new access point identifier.

For example, the rejection code in the open SAP_response message from the gateway 134 will identify the first transceiver 420₁ as being rejected, and includes a new access point identifier for a radio transceiver having less activity than the first transceiver 420₁ (e.g., the second transceiver 420₂ of the first access point 138₁, or an entirely different access point, such as access point 138₂). Accordingly, the gateway 134 may hand-off one or more of the mobile hosts 150 to either a secondary transceiver (e.g., transceiver 420₂₂) in the same access point 138₁ or a different access point that has available bandwidth to accept additional mobile hosts 150, thereby relieving the first transceiver 420₂₁ (or access point) from over usage.

In one embodiment, the gateway 134 periodically unicasts link status request messages to each of the access points 138 registered with that particular gateway. The link status request from the gateway 134 is used to indicate radio link information for an access point. With respect to the mobile hosts, the information requested is specific to the radio link between the mobile host and the access point, while with respect to each access point, the information requested is aggregate values for all mobile hosts connected to that access point. A person skilled in the art will appreciate that the frequency of the link status requests from the gateway to the access points is network dependent, and may vary from network to network depending on the particular loading of such network.

The link status request message may include a request for various types of information, such as number of packets (bytes) successfully transmitted, number of packets (bytes) not successfully transmitted, number of packets that were dropped due to excessive retransmission, number of packets dropped due to timeout (old age), number of packets received, among other information. In one embodiment, the link status request may indicate that all the statistical information illustratively associated with an access point be sent in a link status response message.

Alternatively, the link status request may include one or more bytes (e.g., “SubType=x” (where x is an integer)) indicating specific information to be sent in the response from the access points. For example, a sub type message “SubType=1 may signify that the gateway requests the total number of packets/bytes the access point receives/transmits, as well as the number of error packets. Alternatively, a sub type message “SubType=2 may signify sending the information associated with SubType=1 message, as well as the number of users attached to the access point and the signal strength of the access point, and so forth.

In response to the specific link status request message, each of the access points 138 sends a link status response comprising a statistics report to the gateway 134. The link status response includes a header indicating the address of the gateway and a payload comprising the statistics report, which includes downlink/uplink packets/bytes sent, downlink/uplink packet/byte errors, number of contention attempts/failures, among other statistical information.

Depending on the capability of the access point 138, the statistics report may comprise an aggregation of statistics for the entire access point (i.e., all of the transceivers 420 within the access point) or a predetermined number of transceivers 420 in the access point. The gateway 134 compiles and stores the statistics reports from the access points 138 and uses the information therein to administer load balancing for the access points, admissions, and QOS control functions.

In one embodiment, the communication protocol of the present invention allows the gateway 134 to change the configuration of the radios 420 in an access point 138 using a reconfiguration request command. For example, two access points may be deployed near each other and operating on the same channel (e.g., channel 1), but not within a range that would cause interference therebetween. If a service provider 110 later wished to add another access point (AP3) to increase the wireless data capacity, as well as change one of the existing access points (e.g., AP2) such that it operates on another frequency (e.g., channel 4), the gateway can send AP2 a reconfiguration request message with the frequency field populated with Channel 4. The AP2 will respond back with a reconfiguration response after it has tuned to Channel 4.

The gateway can also send a configuration request message to the new access point (AP3) to configure some radio parameters, for example, contention free period and contention free period max duration, if the radio supports 802.11 PCF function. The 802.11 PCF MAC runs on a cycle consisting of a contention free period and a contention period. It is noted that the period may be changed. For example, in an instance where real-time traffic increases, it may be desirable to also increase the contention free period.

In another embodiment, the reconfiguration request may be utilized in instances where the gateway needs to change the base station system identification (BSSID) of the access point. For example, an access point at a location originally belonging to Company A, is taken over by a new company, Company B. The reconfiguration request may be made by the gateway to change the BSSID of the access point to reflect the name of new Company B.

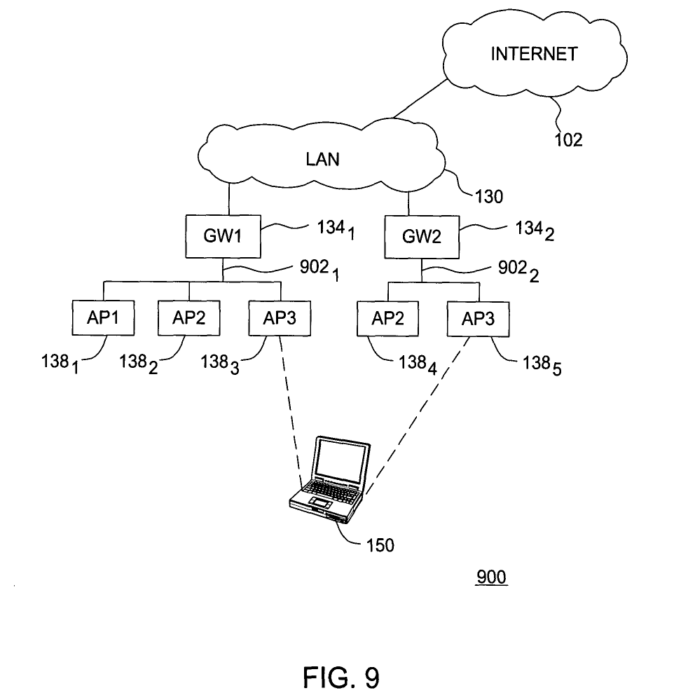

FIG. 9 depicts a block diagram of a third embodiment of a wireless network 900 suitable for use in the present invention. The network comprises at least two gateways (e.g., gateways 134₁, and 134₂) each having at least one access point 138 coupled thereto, as discussed above with respect to FIGS. 1 and 2. For example, the first gateway 134₁ is coupled to first, second and third access points 138₁, 138₂, and 138₃ illustratively via Ethernet wiring 902₁. Similarly, the second gateway 134₂ is coupled to fourth and fifth access points 138₄ and 138₅ illustratively via Ethernet wiring 902₂. The first and second gateways 134₁ and 134₂ are coupled to the Internet 102 via the customer site local area network (LAN) 130. It is noted that the exemplary gateways 134₁, and 134₂ are illustratively coupled to the access points 138 and LAN 130 via Ethernet wiring, or any other high-speed communications medium, as discussed above with respect to FIGS. 1 and 2. Furthermore, the first and second gateways 134₁ and 134₂ are also coupled to each other, illustratively via Ethernet wiring (e.g., LAN 130), among other high-speed communications medium, as discussed above.

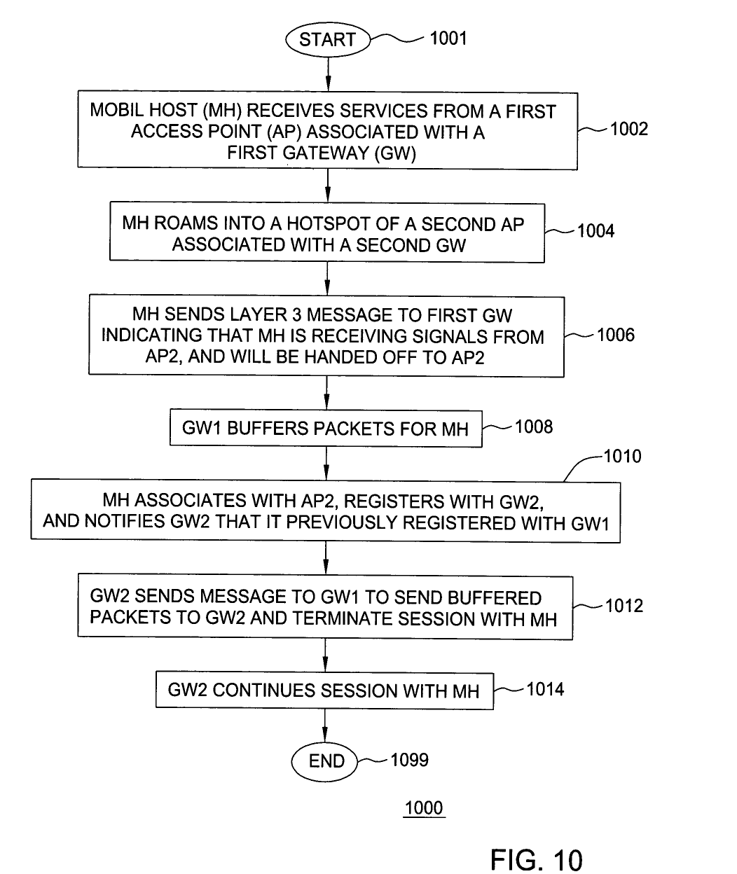

As will be discussed below if further detail with respect to method 1000 of FIG. 10, a mobile host (MH) 150 is illustratively associated and receiving Internet services by the third access point (AP3) 138₃, which is registered with the first gateway 134₁. That is, assume that the MH 150 is roaming from the hotspot region provided by the third access point 138₃ that is associated with the first gateway 134₁, to the hotspot region provided by the fifth access point 138₅ that is associated with the second gateway 134₂. In one embodiment, the communications protocol of the present invention allows the MH 150 to roam, while providing continuous uninterrupted services.

FIG. 10 depicts a flow diagram of a method 1000 for roaming between access points of the wireless network 900 of FIG. 9. FIG. 10 should be viewed in conjunction with FIG. 9. The method 1000 starts at step 1001, and proceeds to step 1002, where the mobile host (MH) 150 is presently associated with a first access point (e.g., access point (AP3) 138₃) and is registered with a first gateway (e.g., gateway (GW) 134₁), from which the MH 150 is receiving either Internet or voice over IP (VoIP) services. The method 1000 then proceeds to step 1004.

At step 1004, the MH 150 roams within range of a second access point (e.g., AP5 138₅), which is associated with a second gateway (e.g., second gateway 134₂. For example, a user may roam from a first merchant in a shopping mall having to a second merchant in the shopping mall, where each merchant has implemented its own gateway. The method 1000 then proceeds to step 1006.

At step 1006, the mobile host 150 sends a layer-3 message to the first gateway GW1 134₁. The layer-3 message may be a user datagram protocol (UDP) message, among others. The layer-3 message includes information indicating that the mobile host 150 is receiving a second beacon signal from a second access point (e.g., AP5 138₅), as well as a notification that the mobile host 150 will attempt to be handed off from the first access point (e.g., AP3 138₃) to the second access point AP5 138₅. Once the first gateway GW1 134₁ receives the layer-3 message from the MH 150, at step 1008, the first gateway GW1 134₁ buffers the packets it is receiving, illustratively from the Internet 102, for the mobile host 150.

At step 1010, the MH 150 associates with the second access point (e.g., AP5 138₅) and registers with the second gateway (e.g., GW2 134₂), as discussed above with respect to FIG. 8. During the registration process, the MH 150 further notifies the second gateway 134₂ that the MH 150 previously registered with the first gateway GW1 134₁. That is, the MH 150 notifies the second gateway that it is currently registered with the first gateway 134₁. The method 1000 then proceeds to step 1012.

At step 1012, the second gateway GW2 134₂ sends a gateway-to-gateway message to the first gateway GW1 134₁, via the LAN 130, instructing the first gateway GW1 134₁ to send the buffered packets to the second gateway 134₂, also via the LAN 130. The gateway-to-gateway message also instructs the first gateway GW1 134₁ to terminate the session with the mobile host 150 once the buffered packets are transferred to the second gateway GW2 134₂.

Once the MH 150 is registered with the second gateway 134₂, at step 1014, the second gateway 134₂ continues the session with the MH 150. Further, the first gateway 134₁ terminates the original session with the MH 150. The method 1000 then proceeds to step 1099, where the method 1000 ends.

Accordingly, the mobile host 150 is able to continue to receive information during a session when roaming from one hotspot to another hotspot, without losing connectivity to the source of information. That is, the only delay seen by the user of the MH 150 is the time that it takes to buffer the information at the first gateway, and then register with the second gateway.

The communications protocol of the present invention allows a gateway in a wireless network environment to monitor the mobile hosts associated with access points registered therewith. Furthermore, the communications protocol allows a user to request various quality-of-service related features, such as best effort or dedicated bandwidth when initiating a request for services from the service provider. Moreover, the communications protocol of the present invention performs load balancing while the users are currently engaged in a session, in a seamless manner, without interruption.

Although various embodiments that incorporate the teachings of the present invention have been shown and described in detail herein, those skilled in the art can readily devise many other varied embodiments that still incorporate these teachings.

1. A method for registering at least one access point with a gateway in a network, comprising:
broadcasting from a gateway, a discovery message to said at least one access point in said network;
receiving from at least one access point receiving said discovery message, an access point registration request comprising access point location, IP address, MAC address, radio type, and power level information of said access point; and
storing said access point registration request information at said gateway.

2. The method of claim 1, wherein each access point selects a random delay prior to sending said access point registration request to said broadcasting gateway.

3. A method for registering at least one access point with a gateway in a network, comprising:
broadcasting a gateway discovery query message from said at least one access point;
receiving from said at least one gateway, a respective service discovery message;
selecting an appropriate gateway in an instance where more than one service discovery message is received; and
sending an access point registration request comprising access point location, IP address, MAC address, radio type, and power level information of said access point to said selected gateway.

4. The method of claim 3, wherein said selecting further comprises:
determining if said access point is currently registered; and
sending said service discovery message to said access point.

5. The method of claim 3, wherein said selecting comprises:
determining an appropriate gateway using at least one of the following: a cost of using a gateway, a load at a gateway, and system features provided by a gateway.

6. The method of claim 3, wherein said sending an access point registration request further comprises sending security information in said access point registration request.

7. The method of claim 6, wherein each access point selects a random delay prior to sending said access point registration request to said gateway.

8. A method of providing data services for a mobile host roaming between access points associated with different gateways, comprising:
receiving wireless services from a first access point associated with a first gateway;
sending a message to said first gateway indicating that said mobile host is receiving signals from a second access point associated with a second gateway;
sending a request to be switched to said second access point to enable thereby a registration with said second gateway; and
receiving buffered packetized information from said first gateway.

9. The method of claim 8, wherein said message to said first gateway comprises a layer-3 type message.

10. The method of claim 8, wherein said sending said buffered packetized information comprises:
sending a message from said second gateway to said first gateway instructing said first gateway to forward said buffered packetized information to said second gateway; and
sending said buffered packetized information from said second gateway.

11. The method of claim 10, further comprising:
instructing said first gateway to terminate wireless services from a first access point associated with a first gateway.

12. A method for providing wireless communications for at least one mobile host in a wireless network environment using a communications protocol comprising an access point location, an access point Internet protocol (IP) address, a media access control (MAC) address, a number of access point radios, a radio type protocol of each access point radio, a radio power level indicator, said method comprising:
associating a mobile host with an access point;
registering said mobile host with a gateway via said communications protocol; and
providing data communications services to said mobile host through said gateway.

13. The method of claim 12, wherein said providing data communications services comprises:
sending a request for services to a gateway including at least one level of quality-of-service (QoS) related features.

14. The method of claim 13, wherein said quality-of-service (QoS) related features comprise at least one of a constant bit rate (CBR), a variable bit rate (VBR), a real-time variable bit rate (VBR-rt), a controlled load, a guarantee service, and a best effort service.

15. A method of providing load balancing for data services for a plurality of mobile hosts, comprising:
receiving a wireless service request from a first transceiver associated with a first mobile host;
determining bandwidth capacity for said first transceiver;
sending a wireless service rejection message to said first mobile host via said first transceiver in an instance where said bandwidth capacity has exceeded a predetermined threshold;
receiving a wireless service request from a second transceiver associated with said first mobile host;
determining bandwidth capacity for said second transceiver; and
sending a wireless service acceptance message to said first mobile host via said second transceiver in an instance where said bandwidth capacity is less than said predetermined threshold.

16. The method of claim 15, further comprising:
providing information to said first mobile host via said second transceiver.

17. The method of claim 15, wherein said first and second transceivers are respectively associated with first and second access points.

18. The method of claim 15, wherein said first and second transceivers are associated with a common access point.

19. In a communications system for providing information, a computer readable medium in a general purpose computer system that operates as a special purpose controller when executing at least one program for broadcasting said information, a communications protocol comprising:
an access point location;
an access point Internet protocol (IP) address;
a media access control (MAC) address;
number of access point radios; and
radio type protocol of each access point radio.

20. The computer readable medium of claim 19, wherein said communications protocol further comprises:
a power level indicator of a currently utilized access point radio.

21. The computer readable medium of claim 19, wherein said communications protocol further comprises:
a frequency channel of each a currently utilized access point radio.

22. The computer readable medium of claim 19, wherein said communications protocol further comprises:
a lifetime indicator of a currently utilized access point radio.

23. The computer readable medium of claim 19, wherein said communications protocol further comprises:
a security indicator of a currently utilized access point radio.

24. The computer readable medium of claim 19, wherein said access point location comprises and alpha-numeric description of a hotspot associated with an access point.

25. The computer readable medium of claim 19, wherein said access protocol IP address comprises a unique IP address of said access point.

26. The computer readable medium of claim 19, wherein said radio type protocol of each access point radio comprises at least one of a radio type selected from the 802.11(a), 802.11(b), 802.11(g), and Bluetooth communication protocols.

27. The computer readable medium of claim 20, wherein said power level indicator provides indicia of signal strength of a beacon signal of an access point radio received by said mobile host.

28. The computer readable medium of claim 22, wherein said lifetime indicator comprises indicia representing temporal connectivity between an access point radio and an associated gateway.

29. The computer readable medium of claim 23, wherein said security indicator comprises privacy keys to allow an access point to communicate with said associated gateway.

30. The computer readable medium of claim 19, wherein said communications protocol further comprises quality-of-service related features.

31. The computer readable medium of claim 30, wherein said quality-of-service related features comprise indicia representing apportioned bandwidth for a mobile host.

32. The computer readable medium of claim 31, wherein said quality-of-service related features comprise indicia of one of a best effort and dedicated bandwidth level of service.
